(19) United States
(12) Patent Application Publication
(10) Pub. No.: US 2017/0194756 A1
(43) Pub. Date: Jul. 6, 2017

(54) USB DATA CABLE CONTAINING EXTENSION INTERFACE AND CONTROL METHOD THEREOF

(71) Applicants: LE HOLDINGS (BEIJING) CO., LTD., BEIJING (CN); LEMOBILE INFORMATION TECHNOLOGY (BEIJING) CO., LTD., BEIJING (CN)

(72) Inventor: Jizeng CHANG, BEIJING (CN)

(21) Appl. No.: 15/242,149

(22) Filed: Aug. 19, 2016

Related U.S. Application Data
(63) Continuation of application No. PCT/CN2016/088468, filed on Jul. 4, 2016.

(30) Foreign Application Priority Data
Dec. 31, 2015 (CN) 201511034151X

(51) Int. Cl. H01R 25/00; H01R 13/70; H01R 13/66; H01R 24/60; H01R 13/646

(52) U.S. Cl. CPC H01R 25/003; H01R 24/60; H01R 13/646; H01R 13/665; H01R 13/70; H01R 2107/00

(57) ABSTRACT

The present disclosure discloses a USB data cable and a control method thereof. The said USB data cable used to extend a Type-C USB interface, comprising: a primary port configured to connect an external first device; a configuration channel module connected to the said primary port; multiple secondary ports configured to connect multiple external second devices; and multiple switch modules connected respectively to the said multiple secondary ports, wherein the said primary port is connected to the said multiple secondary ports via the said multiple switch modules through a USB bus, and the said configuration channel module is connected to the said multiple switch modules through an independent bus, so as to configure the said multiple secondary ports via the said switch modules.

### CROSS REFERENCE TO RELATED APPLICATIONS

The present application is a continuation of PCT application which has an application number of PCT/CN2016/088468 and was filed on Jul. 4, 2016. This application claims priority to Chinese Patent Application No. 201511034151.X, entitled “USB data cable Containing Extension Interface and Control Method Thereof”, filed with the State Intellectual Property Office of People's Republic of China on Dec. 31, 2015, which is incorporated herein by reference in its entirety.

### TECHNICAL FIELD

The present disclosure relates to the field of electronic technology, and more particularly, to a USB data cable comprising an extension interface and a control method thereof.

### BACKGROUND

A universal serial bus (USB) protocol is a protocol for specifying connection and communication between an electronic device and an external device. A USB interface allows for plug and play and hot plug of a device, and therefore is widely used in various computer devices and mobile terminals. Currently, the USB interface has become a standard interface of an electronic device such as a desktop computer, a laptop, a tablet, a mobile phone, or an MP3 player.

The USB interface can support access of multiple devices, and only allows that a primary device supplies power to a secondary device. In mobile phone applications, the USB interface can be used only as a charging port or a data port. When the USB interface is used as a data port, the mobile phone can access an external device, for example, a USB flash drive via the USB interface, and at the same time, supply power to the external device, or the mobile phone is connected to a desktop computer as a secondary device via the USB interface, and at the same time, gains electric energy from the desktop computer. However, a conventional USB interface supports only one-way transmission of electric energy, and therefore cannot support access of a charger and a data peripheral at the same time.

In recent years, a Type-C USB interface is newly added to the USB protocol, which supports high speed data transmission with a speed up to 10 Gb, and does not need to distinguish a front side from a rear side of the interface during use, so that it can be arbitrarily plugged and pulled. Therefore, the Type-C USB interface has a prospect of wide application. Further, the Type-C USB interface further supports bidirectional transmission of electric energy, and can support power supply and charging power with power up to 100 W, so as to realize fast power supply and charging.

It is expected to develop a new USB data cable and a control method thereof, so as to provide an extended port and support simultaneously multiple USB peripherals of different kinds.

### SUMMARY

In view of the foregoing problem, the present disclosure is to provide a USB data cable comprising an extension interface and a control method thereof for overcoming the foregoing problem or at least partially solving the foregoing problem.

According to an aspect of an embodiment of the present disclosure, a USB data cable is provided for extending the Type-C USB interface, and comprises: a primary port configured to connect an external first device; a configuration channel module connected to the primary port; multiple secondary ports configured to connect multiple external second devices; and multiple switch modules connected respectively to the multiple secondary ports, wherein the primary port is connected to the multiple secondary ports via the multiple switch modules through a USB bus, and the configuration channel module is connected to the multiple switch modules through an independent bus, so as to configure the multiple secondary ports via the switch modules.

Optionally, the said first device and the said multiple second devices each include a Type-C USB controller for controlling data communication between the said first device and the said multiple second devices, and the said configuration channel module performs a configuration function of the Type-C USB protocol independently.

Optionally, the said configuration channel module configures the said multiple secondary ports upon plugging-in of a new device, and connects the new device to the USB bus.

Optionally, the said configuration channel module configures the said multiple secondary ports according to types of the said first device and the said multiple second devices.

Optionally, the said first device is a mobile phone, and the said multiple second devices include at least one of the following—a charger, a desktop computer, a laptop, a tablet, a mobile phone or an MP3 player.

Optionally, if one of the said multiple second devices is a charger and the said configuration channel module controls the said multiple switch modules, it disconnects power supply connections between the said charger and the remaining second devices of the said multiple second devices.

Optionally, the said independent bus is an I2C bus.

Optionally, the said primary port is a plug, and the said multiple secondary ports are plugs or sockets.

Optionally, the said USB data cable further comprises: a cable part; a first connection part connected to one end of the said cable portion; and a second connection part connected to the other end of the said cable portion, wherein the said first connection part and the said second connection part each comprise an insulated housing, and the said configuration channel module and the said multiple switch modules are respectively located within any one of the insulated housings of the said first connection part and the said second connection part.

According to another aspect of an embodiment of the present disclosure, a control method of a USB connection cable is provided, which comprises a primary port configured to connect a first device and multiple secondary ports configured to connect multiple second devices. The said method includes: obtaining, by an independent bus, information of configuration channel of the multiple secondary ports; determining types of the said first device and the said multiple second devices on the basis of the information of configuration channel; configuring the said multiple secondary ports according to the types of the said first device and the said multiple second devices; and connecting the said first device and the said multiple second devices to the USB bus.

Optionally, the said multiple secondary ports are configured upon plugging-in of a new device.

Optionally, the said multiple secondary ports are configured not only based on the relationship between the said first device and the said multiple second devices, but also based on relationships between the said multiple second devices.

Optionally, when the said multiple second devices include a charger, it disconnects power supply connections between the charger and the remaining second devices of the said multiple second devices.

Optionally, the independent bus is an I2C bus.

A USB data cable according to an embodiment of the disclosure takes over the configuration function of the Type-C USB protocol with a built-in configuration channel management module, and configures all port pins via an independent I2C bus. The configuration channel of the USB data cable does not need to occupy the USB bus, so that a new device can be connected without interrupting data communication of data peripherals of the secondary ports. For example, when the data peripheral is a USB flash drive and the mobile phone is connected to the USB flash drive for video play, the mobile phone can continue the video play without being interrupted when a charger or a new USB flash drive is connected to the mobile phone.

Also, the configuration channel management module can further provide a power supply protection function to avoid interference or damage between port devices.

The foregoing description is merely illustrative of the technical solution of the disclosure. In order to appreciate the technical means of the disclosure more clearly so as to implement the technical means in accordance with the contents of the description, and in order to make the foregoing and other objects, features and advantages of the disclosure more apparent, particular embodiments of the disclosure will be elaborated below.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 shows a structural schematic diagram of a USB data cable in accordance with an embodiment of the present disclosure;

FIG. 2 shows a circuit block diagram of a USB data cable in accordance with an embodiment of the present disclosure;

FIG. 3 shows a flow chart of a control method of a USB data cable in accordance with an embodiment of the present disclosure;

FIG. 4 schematically shows a block diagram of a computing device for executing a control method of a USB data cable in accordance with an embodiment of the present disclosure; and

FIG. 5 schematically shows a storage unit for maintaining or carrying program codes for implementing a control method of a USB data cable in accordance with an embodiment of the present disclosure.

### DETAILED DESCRIPTION

Exemplary embodiments of the present disclosure will be described below in more detail with reference to the accompanying drawings. Although exemplary embodiments of the present disclosure are illustrated in the drawings, it should be noted that the present disclosure can be embodied in various forms, and shall not be limited to the embodiments set forth herein. Rather, these embodiments are provided to understand the present disclosure more clearly, and fully convey the scope of the present disclosure to those skilled in the art.

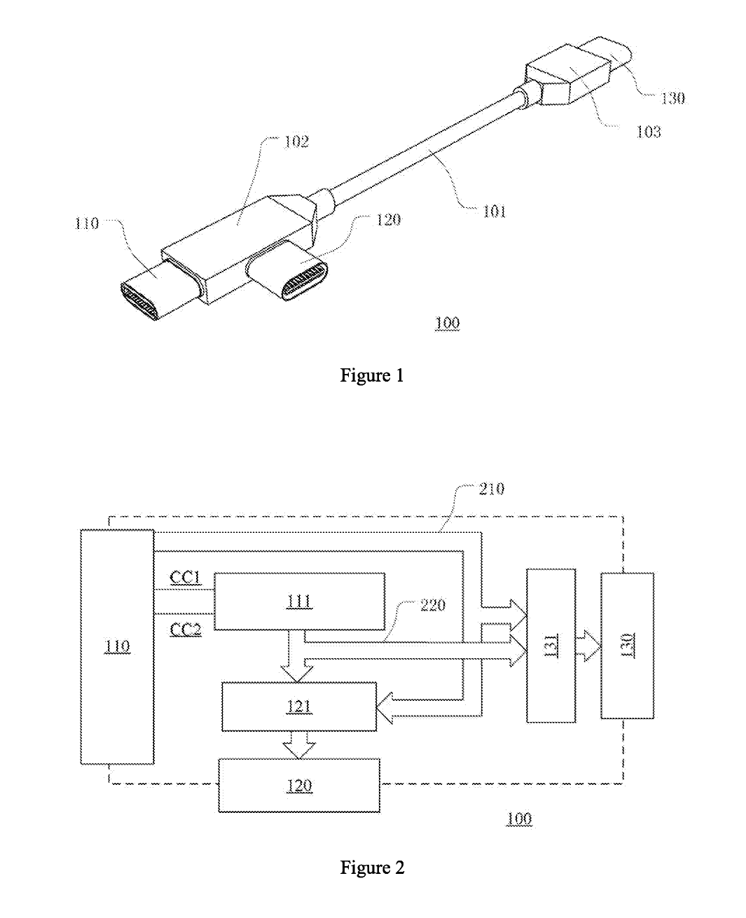

FIG. 1 shows a structural schematic diagram of a USB data cable in accordance with an embodiment of the present disclosure. The USB data cable 100 includes a primary port 110 and two secondary ports 120 and 130. The primary port 110 is, for example, a plug of Type-C USB interface, and the secondary ports 120 and 130 are, for example, sockets of Type-C USB interface.

In this embodiment, taking a mobile phone for instance, the data cable is used for extending a Type-C USB interface of the mobile phone. Since USB interfaces on a mobile phone are typically a socket, the primary port 110 of the USB data cable connected thereto is a plug, and the secondary ports 120 and 130 connected to peripherals are sockets. However, the primary port 110 and the secondary ports 120 and 130 can be either a plug or a socket, regardless of any particular physical forms. Furthermore, as described in this embodiment, the USB data cable includes two secondary ports. However, the number of secondary ports is not limited to two. The USB data cable can comprise multiple secondary ports.

As shown in FIG. 1, the USB data cable 100 also comprises a cable part 101, a first connection part 102 configured to connect one end of the cable part 101 to the primary port 110 and the secondary port 120, and a second connection part 103 configured to connect the other end of the cable part 101 to the primary port 110 and the secondary port 130. The cable part 101 comprises an insulated cover and multiple conducting wires wrapped therein. The first connection part 102 and the second connection part 103 each include an insulated housing and a control circuit wrapped therein.

FIG. 2 shows a circuit block diagram of a USB data cable in accordance with an embodiment of the present disclosure. A control circuit of the USB data cable 100 includes a CC management module 111 (i.e. a configuration channel management module) connected to the primary port 110, and switch modules 121 and 131 connected respectively to the secondary ports 120 and 130.

The primary port 110 is connected to the switch modules 121 and 131 via a USB bus 210. Further, the primary port 110 is mapped to the secondary ports 120 and 130 via the switch modules 121 and 131. As described above, the primary port 110, for example, in the form of a plug, is configured to connect a USB socket of a mobile phone. Further, the secondary ports 120 and 130, for example, in the form of a socket, are used to connect an external charger and data peripherals.

Two configuration channel pins CC1 and CC2 of the primary port 110 are connected to the CC management module 111. The CC management module 111 takes a configuration function of Type-C USB protocol, and is connected to the switch modules 121 and 131 via an independent I2C bus 220. The configuration channel is a key channel of Type-C USB interface, and is used to detect USB connection, to detect proper/opposite plug-in and establish and manage USB device data and bus connection.

In this embodiment, communication between the CC management module 111 and the switch modules 121 and 131 is implemented via an I2C bus. The I2C bus is a double-wire serial bus utilizing a serial data cable (SDL) and a serial clock line (SCL). On the I2C bus, the CC management module 111 initiates communication and transmits a command signal containing address bytes, the switch modules 121 and 131 receive respectively a command signal and only a switch module of the corresponding address feeds back a response signal, so that data is transmitted to or received from the switch module of the corresponding address. Accordingly, the CC management module 111 can initiate two-way data transmission directed to the assigned switch modules 121 and 131, according to a clock signal of I2C its own.

The CC management module 111 using the I2C bus is connected to the switch modules and enables two-way communication via the switch modules. Therefore, the control circuit can be easily extended to support multiple secondary ports. All interface controllers of the said multiple secondary ports are connected to the USB bus and also connected to the I2C bus.

Under control of the CC management module 111, the switch modules 121 and 131 are configured to connect selected pins of the secondary ports 120 and 130 to the USB bus. For example, two peripherals are respectively a charger and a USB flash drive, wherein the charger is typically a primary device and the USB flash drive is typically a secondary device. The switch modules 121 and 131 connect the peripherals to the USB bus only after configuration is complete, so as to adapt to different types of peripherals.

Also, the switch modules 121 and 131 selectively connect the power supply pins of the peripherals to the USB bus. In one embodiment, the peripherals connected to the secondary ports 120 and 130 are respectively a charger and a desktop computer. The switch module 121 connects the power supply pin of the secondary port 120 to the USB bus, so as to supply power to the primary port, such as a mobile phone, via the charger. The switch module 131 disconnects the power supply pin of the secondary port 130 from the USB bus and connects the data channel of the secondary port 130 to the USB bus, which protects the circuit inside the desktop computer from being damaged by current induced by the charger.

The USB data cable according to this embodiment is different from the USB interface in the art, and the USB data cable 100 can not only extend the USB interface but also support access from different types of peripherals at the same time. For example, the primary port of the USB data cable 100 is configured to connect the mobile phone, two secondary ports thereof connect respectively a charger and a USB flash drive, which solves the problem of a limited number of USB ports of the mobile phone and allow data transmission or video play during a heavy-current charging process.

In this embodiment, the CC management module 111 is responsible for configuration function of Type-C USB protocol and configures all the port pins via an independent I2C bus. The configuration channel of the USB data cable does not need to occupy the USB bus, so that a new device can be connected without interrupting data communication of data peripherals of the secondary ports. For example, when the data peripheral is a USB flash drive and the mobile phone is connected to the USB flash drive for video play, the video play in the mobile phone will not be interrupted when the charger or a new USB flash drive is plugged in.

Also, the CC management module 111 can further provide a power supply protection function to avoid interference or damage among devices of the secondary ports.

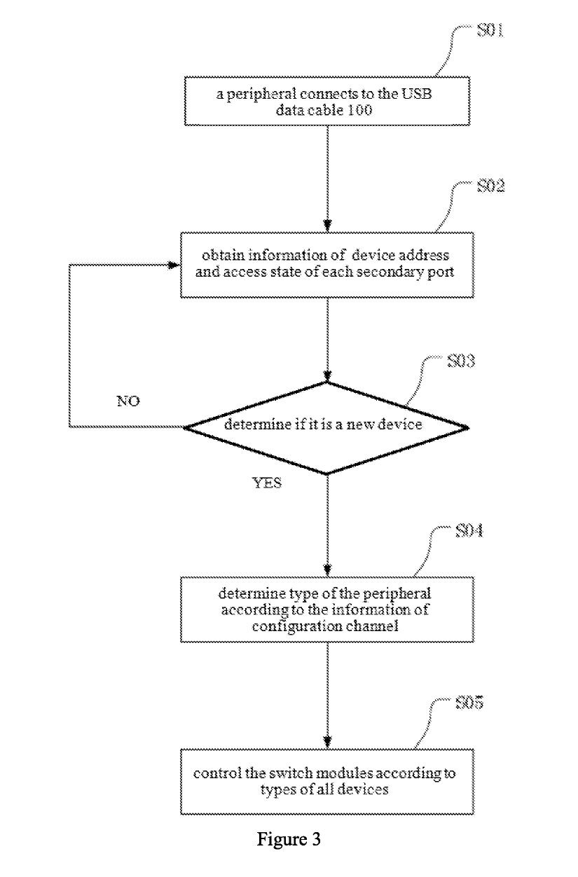

FIG. 3 shows a flow chart of a control method of a USB data cable in accordance with an embodiment of the present disclosure. The control method is implemented by a combination of devices connected to individual ports and a CC management module 111 in a USB data cable 100. For example, the device connected to the primary port is a mobile phone, devices connected to the secondary ports include a charger and a USB flash drive, and each device is provided therein with a Type-C USB controller.

In step S01, a peripheral connects to the USB data cable 100.

In step S02, the CC management module 111 obtains information of configuration channel via the I2C bus, including a device address and access state of each secondary port. Preferably, proper/opposite plug-in information of each secondary port is also gathered in the step.

In step S03, the CC management module 111 determines whether the peripheral device is a new one. If no new peripheral device is accessed, return to step S02. When a new peripheral is connected, proceed to step S04.

In step S04, the CC management module 111 determines type of the peripheral according to the information of configuration channel, for example, taking the charger as a primary device of the mobile phone and the USB flash drive as a secondary device.

In step S05, the CC management module 111 controls the switch modules 121 and 131 according to types of all devices, so as to configure pins of individual ports. For example, if a peripheral of the secondary port is a charger, a Vbus pin is configured as USB Power Delivery mode, and if a peripheral of the secondary port is a USB flash drive, a Vbus pin is configured as USB Type-C mode.

In this step, the CC management module 111 can configure the port pins not only based on the relationship between the device of the primary port and the devices of the secondary ports but also based on relationships between the devices of the secondary ports.

In one embodiment, the peripherals connected to the secondary ports 120 and 130 are respectively a charger and a desktop computer. The switch module 121 connects the power supply pin of the secondary port 120 to the USB bus, so as to supply power to a primary port, such as a mobile phone, via the charger. The switch module 131 disconnects the power supply pin of the secondary port 130 from the USB bus and connects the data channel of the secondary port 130 to the USB bus, so as to protect the circuit within the desktop computer from being damaged by the charger current.

The algorithm and display provided here have no inherent relation with any specific computer, virtual system or other devices. Various general-purpose systems can be used together with the teaching based on this. According to the description above, the structure required to build this kind of system is obvious. Besides, the disclosure is not directed at any specific programming language. It should be understood that various programming languages can be used for achieving contents of the disclosure described herein, and the above description of a specific language is for disclosing the optimum embodiment of the disclosure.

The description provided herein provides a plenty of details. However, it can be understood that embodiments of the disclosure can be implemented without these specific details. The known methods, structure and technology are not shown in detail in some embodiments, so as not to obscure understanding of the description.

Similarly, it should be understood that in order to simplify the disclosure and help to understand one or more of the various aspects of the disclosure, the various features of the disclosure are sometimes grouped into a single embodiment, drawings, or description thereof in the above description of the exemplary embodiments of the disclosure. However, the method disclosed should not be explained as reflecting the following intention: that is, the disclosure sought for protection claims more features than the features clearly prescribed in every claim. To be more precise, as is reflected in the following claims, the aspects of the disclosure are less than all the features of a single embodiment disclosed above. Therefore, the claims according to a specific embodiment are explicitly incorporated into the specific embodiment thereby, wherein every claim itself as an independent embodiment of the disclosure.

Those skilled in the art can understand that adaptive changes can be made to the modules of the devices in the embodiment and the modules can be installed in one or more devices different from the embodiments. The modules or units or elements in the embodiment can be combined into one module or unit or component, and furthermore, they can be separated into more sub-modules or sub-units or sub-components. Except such features and/or processes or that at least some in the unit are mutually exclusive, any combinations can be adopted to combine all the features disclosed by the description (including the attached claims, abstract and figures) and any method or all process of the device or unit disclosed as such. Unless there is otherwise explicit statement, every feature disclosed by the description (including the attached claims, abstract and figures) can be replaced by substituting features providing the same, equivalent or similar purpose.

In addition, those skilled in the art can understand that although some embodiments described here include some features instead of other features included in other embodiments, the combination of features of different embodiments means falling into the scope of the disclosure and forming different embodiments. For example, in the following claims, any one of the embodiments sought for protection can be used in various combinations.

The various components embodiments of the disclosure can be realized by hardware, or realized by software modules running on one or more processors, or realized by combination thereof. A person skilled in the art should understand that microprocessor or digital signal processor (DSP) can be used for realizing some or all functions of some or all components according to the embodiments in the disclosure in practice. The disclosure can also realize one part of or all devices or programs (for example, computer programs and computer program products) used for carrying out the method described here. Such programs for realizing the disclosure can be stored in computer readable medium, or can possess one or more forms of signal. Such signals can be downloaded from the Internet website or be provided at signal carriers, or be provided in any other forms.

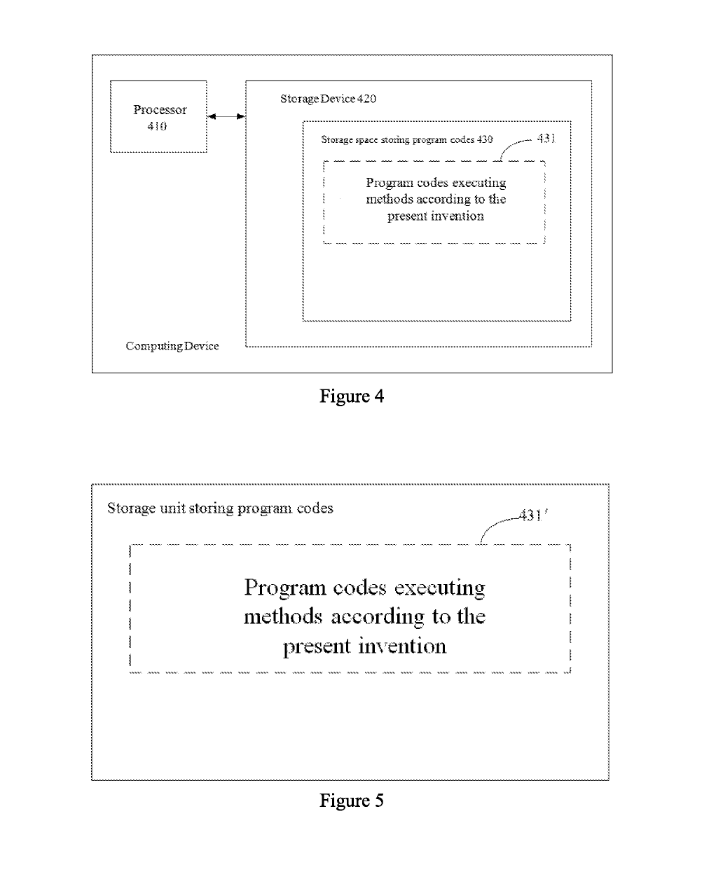

For example, FIG. 4 shows a computing device for achieving a control method of a USB data cable having an interface extension according to the disclosure. The computing device traditionally includes a processor 410 and a computer program product or a computer readable medium embodying as a storage device 420. The storage device 420 can be an electronic storage such as flash memory, EEPROM (Electrically Erasable Programmable Read-Only Memory), EPROM, hard drive or ROM, and the like. The storage device 420 possesses storage space 430 for storing program codes 431 for carrying out any steps of aforesaid method. For example, storage space 430 for storing program codes can include various program codes 431 used for realizing any steps of aforesaid method. These program codes can be read out from one or more computer program products or write in one or more computer program products. The computer program products include program code carriers such as hard disk, Compact Disc (CD), memory card or floppy disk and the like. These computer program products usually are portable or fixed storage cell as shown in FIG. 5. The storage cell can possess memory paragraph, storage space like the storage device 420 in the computing device in FIG. 4. The program code can be compressed in, for example, a proper form. Generally, storage cell includes computer readable code 431′ for performing method steps of the disclosure, i.e. the code can be read by processors such as 410 and the like. When the codes run on a computer device, the computer device will carry out various steps of the method described above.

It should be noticed that the embodiments are intended to illustrate the disclosure and not limit this disclosure, and a person skilled in the art can design substitute embodiments without departing from the scope of the appended claims. In the claims, any reference marks between brackets should not be constructed as limit for the claims. The word “include” does not exclude elements or steps that are not listed in the claims. The word “a” or “one” before the elements does not exclude that more such elements exist. The disclosure can be realized by means of hardware including several different elements and by means of properly programmed computer. In the unit claims several devices are listed, several of the devices can be embodied by a same hardware item. The use of words first, second and third does not mean any sequence. These words can be explained as name.

1. A USB data cable used to extend a Type-C USB interface, comprising:
a primary port configured to connect an external first device;
a configuration channel module connected to the said primary port;
multiple secondary ports configured to connect multiple external second devices; and
multiple switch modules connected respectively to the said multiple secondary ports,
wherein the said primary port is connected to the said multiple secondary ports via the said multiple switch modules through a USB bus, and the said configuration channel module is connected to the said multiple switch modules through an independent bus, so as to configure the said multiple secondary ports via the said switch modules.

2. The USB data cable according to claim 1, wherein the said first device and the said multiple second devices each comprise a Type-C USB controller for controlling data communication between the said first device and the said multiple second devices, and the said configuration channel module independently performs a configuration function of the Type-C USB protocol.

3. The USB data cable according to claim 2, wherein the said configuration channel module configures the said multiple secondary ports upon plugging-in of a new device, and connects the said new device to the USB bus.

4. The USB data cable according to claim 3, wherein the said configuration channel module configures the said multiple secondary ports according to types of the said first device and the said multiple second devices.

5. The USB data cable according to claim 1, wherein the said first device is a mobile phone, and the said multiple second devices comprise at least one device which can be a charger, a desktop computer, a laptop, a tablet, a mobile phone or an MP3 player.

6. The USB data cable according to claim 5, wherein one of the said multiple second devices is a charger and the said configuration channel module controls the said multiple switch modules, power supply connections between the said charger and remaining second devices of the said multiple second devices are consequently disconnected.

7. The USB data cable according to claim 1, wherein the said independent bus is an I2C bus.

8. The USB data cable according to claim 1, wherein the said primary port is a plug, and the said multiple secondary ports are plugs or sockets.

9. The USB data cable according to claim 1, further comprising:
a cable part;
a first connection part connected to one end of the said cable part; and
a second connection part connected to the other end of the said cable part,
wherein the said first connection part and the said second connection part each comprise an insulated housing, and
the said configuration channel module and the said multiple switch modules are respectively located within any one of the insulated housings of the said first connection part and the said second connection part.

10. A method of controlling a USB connection cable which comprises a primary port for connecting a first device and multiple secondary ports for connecting multiple second devices, comprising:
obtaining information of configuration channel of the multiple secondary ports via an independent bus;
determining types of the said first device and the said multiple second devices according to the said information of configuration channel;
configuring the said multiple secondary ports according to types of the said first device and the said multiple second devices; and
connecting the said first device and the said multiple second devices to the USB bus.

11. The method according to claim 10, wherein the said multiple secondary ports are configured upon plugging-in of a new device.

12. The method according to claim 10, wherein the said multiple secondary ports are configured not only based on the relationship between the said first device and the said multiple second devices, but also based relationships between the said multiple second devices.

13. The method according to claim 10, wherein, provided that the said multiple second devices comprise a charger, power supply connections between the said charger and remaining second devices of the said multiple second devices are consequently disconnected.

14. The method according to claim 10, wherein the said independent bus is an I2C bus.
